(19) United States
(12) Patent Application Publication
(10) Pub. No.: US 2020/0406188 A1
(43) Pub. Date: Dec. 31, 2020

(54) BIO-FILTER SYSTEM

(71) Applicant: KOREA ADVANCED INSTITUTE OF SCIENCE AND TECHNOLOGY, Daejeon (KR)

(72) Inventors: Hong Woon LEE, Seoul (KR); Suk Hwan YOON, Daejeon (KR); Young Mo KIM, Gwangju (KR)

(21) Appl. No.: 16/975,808

(22) PCT Filed: Feb. 27, 2019
(86) PCT No.: PCT/KR2019/002354

§ 371 Date: Aug. 26, 2020

(30) Foreign Application Priority Data
Feb. 27, 2018 (KR) 10-2018-0023428

(51) Int. Cl. B01D 53/85; B01D 53/56; C02F 3/10

(52) U.S. Cl. CPC B01D 53/85; C02F 3/302; C02F 3/106; B01D 53/565

(57) ABSTRACT

A bio-filter system is disclosed. The disclosed bio-filter system comprises: a transfer pipe for collecting and transferring N₂O generated in any one tank from among an anaerobic tank, an anoxic tank, and an aeration tank; a bio-filter unit including a carrier for removing, by means of microbial reaction, the N₂O discharged from the transfer pipe; and a sewage supply member for spraying sewage into the carrier in order to provide nourishment for microorganisms to the carrier. The bio-filter unit comprises: a filter housing; an induction discharge pipe, which is installed on the lower side of the inside of the filter housing, for inducing the N₂O transferred by the transfer pipe in a transverse direction and enabling same to be discharged upwardly through a nozzle; the carrier, which is disposed on the upper side of the induction discharge pipe inside the filter housing, for removing, by means of microbial reaction, the N₂O discharged through the induction discharge pipe; and a sewage spraying member, which is disposed on the top of the carrier inside the filter housing, for spraying sewage supplied from the sewage supply member to the carrier so as to utilize the sewage as nourishment for microorganisms.

### TECHNICAL FIELD

The present invention relates to a bio-filter system for actively removing a low concentration (<100 ppmv) of N₂O (nitrous oxide) discharged from a small-scale sewage treatment plant.

### BACKGROUND ART

Although nitrous oxide (N₂O) is present at a concentration of at most 320 ppbv in the atmosphere, it has a global warming potential (GWP) 300 times higher than carbon dioxide, so even the removal of a small amount thereof can provide a high effect. Since N₂O is a compound that also contributes to the destruction of the ozone layer in the stratosphere, the generation thereof must be reduced.

Most of the N₂O discharged into the atmosphere is produced by biological denitrification and nitrification reactions. The denitrification reaction is a reaction in which nitrate (NO₃⁻) is reduced to N₂ stepwise through nitrite (NO₂⁻), nitric oxide (NO), and N₂O , and each reaction step is performed by different enzymes. Some denitrifying microorganisms do not have the gene for nitrous oxide reductase that reduces N₂O and thus discharge N₂O itself produced by the denitrification reaction, so they are recognized as a major source of N₂O. Also, some denitrifying microorganisms that have the gene for nitrous oxide reductase are known to produce N₂O according to various environmental conditions. The nitrification reaction is a reaction in which ammonia (NH₄⁺) is oxidized by aerobic nitrifying microorganisms to produce NO₂⁻, and NO₂⁻is also oxidized to produce NO₃⁻. Ammonia-oxidizing bacteria (ammonia oxidizers) often have the genes for nitrite reductase and nitric oxide reductase, and it is known that when they are expressed, nitrifier denitrification occurs to produce N₂O (see FIG. 1).

N₂O discharged from the environment occurs naturally in the soil and marine environments, but the generation thereof has been greatly increased by human activities such as agricultural activities, sewage treatment, and the like. The leading source of N₂O is agricultural land, and N₂O is produced by nitrification and denitrification reactions of a nitrogen fertilizer. However, since N₂O from agricultural land is generated at a very low concentration over a large area, it is virtually impossible to remove it by engineering methods.

In addition, a high concentration of N₂O is generated in the production process of nitric acid or adipic acid, but a catalyst may be used to achieve a removal rate of 95% or more. However, it is known that even after the catalytic treatment, about 1,000 ppmv of N₂O remains in the exhaust gas.

Looking at the main sources of N₂O, the only N₂O discharged at a high concentration of 1% or more is N₂O generated in the production process of adipic acid, and it is practically impossible to subject N₂O generated from agricultural land, livestock manure, a nitric acid production process, a power plant, an internal combustion engine, a sewage treatment plant, and the like to chemical treatment using a catalyst due to its low concentration. Even in the case of N₂O generated at a concentration of 30 to 50% in the production process of adipic acid, a considerable amount of N₂O remains after chemical treatment, so re-treatment is necessary.

### DISCLOSURE

### Technical Problem

The present invention is directed to providing a bio-filter system capable of effectively removing not only a high concentration of N₂O but also a low concentration of N₂O without using energy or chemicals by actively utilizing the characteristics of a sewage treatment plant.

However, the technical objectives of the present invention are not limited to those described above, and other unmentioned technical objectives will be clearly understood by those skilled in the art from the following description.

### Technical Solution

One aspect of the present invention provides a bio-filter system which includes: a transfer pipe configured to collect and transfer N₂O generated in any one tank of an anaerobic tank, an anoxic tank, and an aeration tank; a bio-filter unit including a carrier for removing, by means of a microbial reaction, the N₂O discharged from the transfer pipe; and a sewage-supplying member configured to supply sewage into the carrier for providing nutrients for microorganisms to the carrier, wherein the bio-filter unit includes: a filter housing; a guidance discharge pipe disposed at a lower part inside the filter housing and configured to discharge the N₂O transferred by the transfer pipe upwards through a nozzle while guiding the N₂O in a transverse direction; a carrier disposed above the guidance discharge pipe inside the filter housing and configured to remove, by means of a microbial reaction, the N₂O discharged through the guidance discharge pipe; and a sewage-spraying member disposed above the carrier inside the filter housing and configured to spray sewage supplied from the sewage-supplying member into the carrier for use as nutrients for microorganisms.

According to an embodiment of the present invention, a bottom of the filter housing may be formed to be inclined in order to collect sewage dropped from the carrier at one side, and a pump configured to pump the collected sewage for supply to the sewage-supplying member may be further included.

According to an embodiment of the present invention, a sewage tank of the sewage-supplying member may be disposed above the sewage-spraying member so as to supply sewage to the sewage-spraying member by gravity.

According to an embodiment of the present invention, the carrier may consist of an open cell portion with a 70% void volume for facilitating gas transfer and a closed cell portion with a 30% void volume in which microorganisms are able to be securely immobilized, have a porosity of 11 to 13 ppi and a density of 35 kg/m³, and may be made of a polypropylene resin.

According to an embodiment of the present invention, the guidance discharge pipe may be designed to gradually decrease in cross-sectional area as the distance from the transfer pipe increases.

### Advantageous Effects

A conventional N₂O reduction technology using a chemical catalyst has a limited effect of reducing only a high concentration of N₂O, whereas, according to an embodiment of the present invention, it is possible to reduce a low concentration of N₂O as well, thereby improving N₂O reduction efficiency.

In particular, carbon-zero operation is possible by utilizing the introduced sewage itself as nutrients for microorganisms and an electron donor and utilizing a height difference and a pressure difference present in the design of a general sewage treatment plant.

However, it is to be understood that the effects of the present invention are not limited to the above-described effects but include all effects deducible from the configuration of the invention described in the detailed description or claims of the present invention.

### DESCRIPTION OF DRAWINGS

FIG. 1 is a biological nitrogen cycle diagram.

FIG. 2 is a schematic diagram of a bio-filter system according to the present invention.

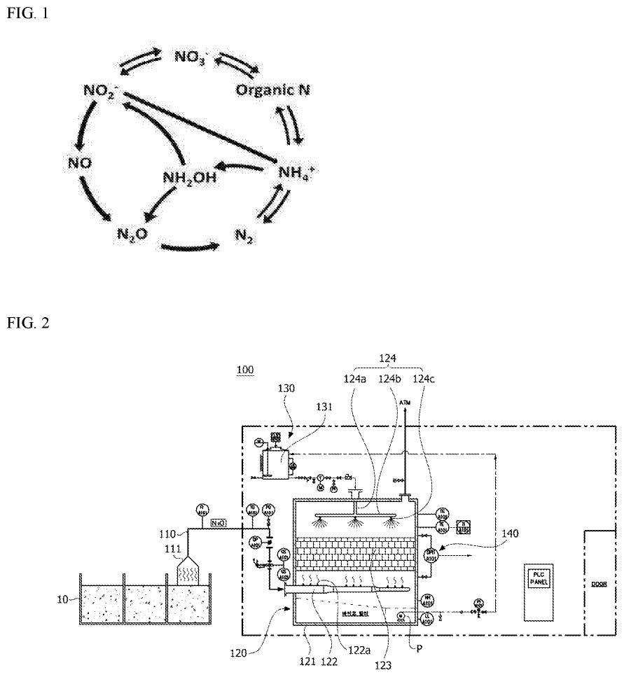

### MODES OF THE INVENTION

Hereinafter, the present invention will be described in detail with reference to embodiments. However, the present invention may be embodied in several different forms and, therefore, is not limited to embodiments described herein. Also, in the drawings, descriptions of parts unrelated to the detailed description are omitted to clearly describe the present invention, and throughout the specification, like numbers refer to like elements.

Throughout this specification, when a part is mentioned as being “connected (contacted, coupled)” to another part, this means that the part may not only be “directly connected” to the other part but may also be “indirectly connected” to the other part through another member interposed therebetween. In addition, when a part is mentioned as “including” a specific component, this does not preclude the possibility of the presence of other component(s) in the part which means that the part may further include the other component(s), unless otherwise stated.

The terms used herein have been used only for the purpose of describing particular embodiments and are not intended to limit the present invention. In the present specification, singular expressions include plural expressions unless the context clearly indicates otherwise. It will be further understood that the terms “comprises,” “comprising,” “includes,” “including,” “has” and/or “having,” when used herein, specify the presence of stated features, integers, steps, operations, elements, components and/or groups thereof, but do not preclude the presence or addition of one or more other features, integers, steps, operations, elements, components and/or groups thereof.

Hereinafter, embodiments of the present invention will be described in detail with reference to the accompanying drawings.

A bio-filter system according to the present invention is capable of effectively reducing not only a high concentration of N₂O but also a low concentration of N₂O without using energy or chemicals by actively utilizing the characteristics of a sewage treatment plant, and the detailed configuration thereof is as follows.

A bio-filter system 100 according to the present invention includes a transfer pipe 110, a bio-filter unit 120, and a sewage-supplying member 130.

The transfer pipe 110 serves to collect N₂O generated in any one tank of an anaerobic tank, an anoxic tank, and an aeration tank 10 and transfer the same to the bio-filter unit 120. At one end of the transfer pipe 110, a collection cup 111 disposed at an upper part of the aeration tank 10 and configured to collect N₂O discharged upwards from the aeration tank may be provided.

The bio-filter unit 120 is for removing the N₂O discharged from the transfer pipe 110 by means of a microbial reaction and may include a filter housing 121, a guidance discharge pipe 122, a carrier 123, and a sewage-spraying member 124.

The filter housing 121 is provided with a closed structure, and an air outlet 121a for discharging N₂O -free air may be provided at an upper part of the filter housing.

In addition, the filter housing 121 is disposed below a sewage tank 131 for supplying sewage to the carrier 123. Therefore, since sewage in the sewage tank 131 may be supplied without power (by gravity), the manufacturing cost of the device may be reduced.

Additionally, a bottom of the filter housing 121 may be formed to be inclined downward from one side towards the other side in order to collect sewage dropped from the carrier 123 at one side, and the collected sewage may be recovered and recycled to the sewage-supplying member 130 by pumping by a pump p.

The guidance discharge pipe 122 is disposed at a lower part inside the filter housing 121 and serves to discharge the N₂O transferred by the transfer pipe 110 towards the carrier 123 through a nozzle 122a while guiding the N₂O in a transverse direction.

In this case, the guidance discharge pipe 122 may be designed to gradually decrease in cross-sectional area as the distance from the transfer pipe 110 increases. The reason for this design is that the volumetric flow rate of N₂O discharged through individual nozzles is only constant when N₂O introduced through the inlet of the guidance discharge pipe 122 has a constant volumetric flow rate until it reaches the end of the guidance discharge pipe, but when the cross-sectional areas of the guidance discharge pipe at the inlet and the end are the same, considering that N₂O is discharged in the middle through the nozzles, the flow rate of N₂O may not be constant, and therefore, the cross-sectional area gradually decreases as the distance from the inlet increases, so that a linear velocity increases, and a uniform flow of N₂O is discharged throughout the guidance discharge pipe.

The carrier 123 is disposed above the guidance discharge pipe 122 inside the filter housing 121 and serves to remove the N₂O discharged through the guidance discharge pipe by means of a microbial reaction.

The carrier 123 may be provided in the form of any one of a wood chip, a ceramic, and polyurethane foam. Since the organic wood chip consists of a carbon source which is a food source for microorganisms, it is advantageous to effectively attach microorganisms to the carrier at the initial stage of inoculation of microorganisms, but there is a disadvantage in which the removal efficiency of contaminants is significantly degraded by a large pressure difference as the waste gas passes due to the channeling of the packing layer of the wood chip occurring over time. The ceramic carrier has physical properties that are advantageous for microorganisms to be attached to and grown naturally in the carrier due to porous characteristics of the carrier, but has a limitation in attaching a high concentration of microorganisms due to the pore size of the ceramic carrier. Therefore, the ceramic carrier has low contaminant removal efficiency compared to the organic wood chip and an economic drawback such as a high unit cost.

On the other hand, since the polyurethane foam consists of a non-biodegradable material and thus is not oxidized by microorganisms that grow naturally in the packing layer, it has a semi-permanent lifespan of 30 years or more.

In addition, since the polyurethane foam uniformly and sufficiently provides pores, it is advantageous for adsorption and desorption of microorganisms, and since the polyurethane foam is capable of carrying many microorganisms by sufficiently providing the habitat space for microorganisms, it has high commercial application potential as a single carrier.

In particular, the polyurethane foam preferably has a porosity of 11 to 13 ppi and a density of 35 kg/m³.

The sewage-spraying member 124 is disposed above the carrier inside the filter housing 121 and serves to spray sewage supplied from the sewage-supplying member 130 into the carrier 123 for use as nutrients for microorganisms. The sewage-spraying member 124 may include: a main pipe 124a connected to the sewage tank 131 of the sewage-supplying member 130; a spray pipe 124b connected to the main pipe 124a and disposed along a longitudinal direction of the carrier 123; and a plurality of spray nozzles 124c disposed at predetermined sites of the spray pipe 124b and configured to spray sewage towards the carrier 123.

As described above, since the sewage-spraying member 124 is disposed below the sewage-supplying member 130, the sewage in the sewage-supplying member is supplied, without power, by gravity and sprayed. For this reason, there are no need for a separate spray pump and the like and no power consumption, and thus it is economically advantageous.

A reference numeral 140 is a differential pressure gauge for measuring a pressure difference between a space above the carrier 123 and a space under the carrier 123.

According to the bio-filter system 100 of the present invention which has the above-described configuration, N₂O generated in the aeration tank 10 is collected by the collection cup 111, the collected N₂O is introduced into the guidance discharge pipe 122 through the transfer pipe 110, and the introduced N₂O is introduced, through a plurality of nozzles 122a disposed at an upper part of the guidance discharge pipe, into the carrier 123 which is disposed above the nozzles. The N₂O introduced into the carrier 123 is eliminated in a biological manner using a microbial reaction. This biological manner of elimination allows 50 to 60% of not only a high concentration of N₂O but also a low concentration of N₂O to be eliminated.

In addition, since sewage supplied from the sewage-supplying member 130 is sprayed into the carrier 123 and utilized as nutrients for microorganisms and an electron donor, the carrier 123 may function to continuously remove N₂O. Therefore, costs may be reduced by utilizing the sewage-supplying member 130 which is an existing facility without requiring an additional facility for supplying nutrients for microorganisms to the carrier 123.

In addition, sewage dropped from the carrier 123 is collected at one side due to the inclined bottom of the filter housing 121, and the collected sewage is recovered and recycled to the sewage tank 131 of the sewage-supplying member 130 by pumping by the pump p.

Meanwhile, the filter housing 121, especially, the inner surface of the upper part thereof, is preferably coated to prevent contamination. This is because, when the inside of the filter housing 121 is contaminated, contaminants present inside may be discharged together with air discharged through the air outlet 121a.

An anti-contamination coating agent mainly includes an inorganic oxide, a cellulose-based compound, and a solvent. Specifically, the anti-contamination coating agent may include 5 to 10 parts by weight of an inorganic oxide consisting of aluminum oxide (Al₂O₃), silicon oxide (SiO₂), and titanium oxide (TiO₂), 1 to 10 parts by weight of a cellulose-based compound, and 50 to 1,000 parts by weight of a solvent.

The inorganic oxide serves to maintain hydrophilicity for a long time and improve the strength and durability of a coating film. In addition, the inorganic oxide is preferably included in an amount of 5 to 10 parts by weight. This is because, when the content of the inorganic oxide is less than 5 parts by weight, the hydrophilicity of a coating film is degraded, and the water resistance and durability of a coating film are significantly degraded.

On the other hand, when the content of the inorganic oxide exceeds 10 parts by weight, a coating film may crack, and the adhesion of a coating film may be degraded, thereby limiting the type of object to be coated.

The inorganic oxide may impart characteristics according to the type and mixed composition thereof. For example, when anatase-type titanium dioxide is used, the anti-contamination coating agent may exhibit photocatalytic performance, when silicon oxide is used alone, the anti-contamination coating agent may exhibit non-photocatalytic performance, and when aluminum dioxide is used alone, an anti-contamination coating agent having high strength and improved durability may be formed. Therefore, it is possible to prepare a more effective anti-contamination coating agent by mixing components in an appropriate ratio in consideration of these characteristics.

Using this principle, in the present invention, the silicon oxide, aluminum oxide, and titanium oxide may be mixed in an appropriate ratio to compensate for the disadvantages of an existing photocatalytic coating agent and a fluorine coating agent.

In addition, the inorganic oxide preferably includes the aluminum oxide at 10 to 30 wt %, the silicon oxide at 20 to 45 wt %, and the titanium oxide at 25 to 50 wt %. This is because the anti-contamination coating agent exhibits not only characteristics of the individual components as described above but also excellent anti-contamination properties within the above mixing proportion of each component.

Additionally, the inorganic oxide is preferably in the form of powder with an average particle diameter of 2 to 15 nm in order to obtain a transparent coating film having high anti-contamination properties.

However, it is noted that the inorganic oxide may be used by directly mixing the 2 to 15 nm powder with a solvent or a solution or by modifying it to various forms such as a sol or a gel in which the inorganic oxide powder is dispersed.

In addition, the mixing ratio and particle size (2 to 15 nm) of the inorganic oxide may contribute to minimizing the thickness of a coating film and ensuring the transparency of a coating film, and, that is, are determined in consideration of an improvement in hydrophilicity and anti-contamination properties of a coating film, transparency of a coating film applied to an object to be coated, and stability of the coating agent, and the like.

A method of preparing nanoparticles of the inorganic oxide powder is not limited, and the nanoparticles may be obtained by methods known in the art. The methods may be classified into a solid phase method, a liquid phase method, a gas phase method, and the like. Among them, the most widely used method is a liquid phase method, and examples thereof include a precipitation method, a coprecipitation method, an impregnation method, a sol-gel method, and the like, but the present invention is not limited thereto.

The cellulose-based compound serves to improve hydrophilicity and disperse and immobilize the inorganic oxide.

The cellulose-based compound may be largely divided into a compound with a cellulose structure and a compound with no cellulose structure.

That is, the cellulose-based compound may be divided into at least one selected from the group consisting of methyl cellulose, ethyl cellulose, carboxy methyl cellulose (CMC), sodium carboxy methyl cellulose, and calcium carboxy methyl cellulose and a compound with no cellulose structure, such as sodium polyacrylate or propylene glycol alginate.

In particular, in the case of the cellulose-based compound with a cellulose structure, the compound is mixed with a solvent and aged for a predetermined time so as to exhibit dispersibility and adhesion. Specifically, when the cellulose-based compound is mixed with a solvent, the volume is expanded in a wet state due to the hydrophilicity of a cellulose structure, and thus the uniform dispersion of the inorganic oxide powder and excellent adhesion are achieved.

The cellulose-based compound is preferably included in an amount of 1 to 10 parts by weight. This is because, when the content of the cellulose-based compound is less than 1 part by weight, the hydrophilicity of a coating film is degraded, and the flexibility of a coating film and the adhesion thereof to an object to be coated are degraded.

On the other hand, when the content of the cellulose-based compound exceeds 10 parts by weight, a coating film becomes vulnerable to moisture, and thus the durability of a coating film is significantly degraded, and anti-contamination properties are also degraded.

As the solvent, water and a C1-C4 lower alcohol are used alone or in combination thereof. Specifically, the solvent preferably consists of a mixture of 300 to 400 parts by weight of water and 50 to 100 parts by weight of a C1-C4 lower alcohol.

In addition, the bottom of the filter housing 121 of the present invention may be coated with an anti-corrosion coating composition to improve corrosion resistance because stagnant sewage is always present on the bottom.

In this case, the anti-corrosion coating composition may include: one or more polyol components having a hydroxyl (OH) group content of 9 wt % to 15 wt % based on the total weight of the polyol component and including one or more polyols selected from the group consisting of polyether polyols, polyester polyols, and polyether polyester polyols; and one or more isocyanate components having an isocyanate (NCO) group content of 10 wt % to 15 wt % based on the total weight of the isocyanate component and including an at least one diisocyanate- or polyisocyanate-terminated polylactone prepolymer.

In this case, the polyol component includes one or more polyols selected from the group consisting of polyether polyols, polyester polyols, and polyether polyester polyols. The polyether polyester polyols are polyols with both a polyester structure and a polyether structure. The polyol is preferably selected from polyether polyols and polyester polyols. It is particularly preferable that a mixture of polyether polyols and polyester polyols is used as the polyol.

A suitable polyether polyol is, for example, polyoxyethylene or polyoxypropylene.

The polyether polyol, polyester polyol, and polyether polyester polyol may be dimerized fatty acids.

Such a polyol may be prepared, for example, by esterification of a polyhydric alcohol and a dimerized fatty acid and subsequent polymerization.

A starting compound used in the condensation reaction may be an amine, for example, 3,5-diethyl-2,4-toluenediamine or 3,5-diethyl-2,6-toluenediamine. The reaction is terminated when a desired OH content is reached. In addition, polyether polyols, polyester polyols, and polyether polyester polyols, which are dimerized fatty acids, may be obtained by epoxidation of dimerized fatty acids, subsequent reactions with polyhydric alcohols and/or polybasic carboxylic acids, and subsequent polymerization.

A suitable dimerized fatty acid is obtained, for example, from natural oils such as soybean oil, rapeseed oil, castor oil, sunflower oil, and palm oil.

The polyol component may further include, for example, other polyols such as polylactone, polyacrylate, and/or polyepoxide.

The polyol component preferably includes a polyol selected from the group consisting of polyether polyols, polyester polyols, and polyether polyester polyols at 50 wt % or more based on the total weight of the polyol component. The content of the polyol is preferably 80 wt %, more preferably 90 wt %, and most preferably 100 wt %.

The polyol of the polyol component may be linear or branched. Preferably, the polyol is branched. In addition, the polyol of the polyol component may be saturated or unsaturated, and a saturated polyol is preferred.

The fraction of the polyol component is preferably 5 wt % to 30 wt %, and more preferably, 15 wt % to 25 wt % based on the total weight of the composition. The sum of all components in the present invention is 100 wt %.

The polyol component preferably includes an OH group at a fraction of 10 wt % to 12 wt % based on the total weight of the polyol component.

The polyol component preferably has an acid value of 0 to 3 mg KOH/g based on a solid content. The acid value is measured in accordance with ISO 660.

The OH group content of the polyol component is preferably 9 wt % to 13 wt % based on the total weight of the polyol component. The OH group content may be measured by a hydroxyl number. The hydroxyl number is measured in accordance with DIN 53240.

The polyol component preferably has a solid content of 95 wt % to 100 wt %. The solid contents of the composition and components thereof are measured in accordance with DIN ISO 3251 under conditions of an initial mass of 1.0 g, a test time of 60 minutes, and a temperature of 125° C.

Each polyol of the polyol component may have a weight-average molecular weight of 160 to 4,000 g/mol, and preferably, 160 to 2,000 g/mol.

The polyol component preferably has a weight-average molecular weight of 160 to 800 g/mol. The weight-average molecular weight of the polyol component is preferably 180 to 600g/mol, and particularly preferably, 200 to 500 g/mol.

The molecular weights of all the above-described compounds, unless indicated otherwise, are measured by gel permeation chromatography (GPC) analysis using tetrahydrofuran (THF; +0.1 wt % acetic acid based on the weight of THF) as eluent (1 ml/min) on a styrene-divinylbenzene column combination. Calibration is made with a polystyrene standard.

The isocyanate component includes an at least one diisocyanate- or polyisocyanate-terminated polylactone prepolymer. This means that a prepolymer is terminated with at least one diisocyanate or at least one polyisocyanate. The prepolymer is preferably diisocyanate-terminated. The terminal NCO group may be entirely or partially blocked or not blocked at all. Preferably, the terminal NCO group is not blocked.

The prepolymer may have a weight-average molecular weight of 500 to 4,000 g/mol, preferably 1,000 to 3,000 g/mol, and more preferably 1,800 to 2,200 g/mol.

The prepolymer may be prepared from lactones and one or more diols or polyols as starting molecules. Diols, especially, diols with a terminal OH group, are preferred. Suitable diols or polyols include neopentyl glycol, ethylene glycol, and trimethylolpropane. Suitable lactones include oxiran-2-one, β-propiolactone, γ-butyrolactone, γ-valerolactone, ϵ-caprolactone, and methyl-ϵ-caprolactone, preferably γ-butyrolactone and ϵ-caprolactone, and more preferably ϵ-caprolactone. Therefore, a polybutyrolactone prepolymer and a polycaprolactone prepolymer are preferable polylactone prepolymers. The polycaprolactone prepolymer is particularly preferred. The NCO group fraction in the prepolymer is preferably 6 wt % to 12 wt % based on the total weight of the prepolymer. The fraction is preferably 7 wt % to 10 wt %, and more preferably, 8 wt % to 9 wt %.

While the above-described embodiments illustrate exemplary embodiments of the present invention, it will be apparent that the present invention can be embodied in various forms within the spirit and scope of the present invention without being limited thereto.

### LIST OF REFERENCE NUMERALS

| | |
|---|---|
| 100: bio-filter system | 110: transfer pipe |
| 120: bio-filter unit | 121: filter housing |
| 122: guidance discharge pipe | 123: carrier |
| 124: sewage-spraying member | 130: sewage-supplying member |
| 131: sewage tank | |

1. A bio-filter system comprising:
a transfer pipe configured to collect and transfer N₂O generated in any one tank of an anaerobic tank, an anoxic tank, and an aeration tank;
a bio-filter unit including a carrier for removing, by means of a microbial reaction, the N₂O discharged from the transfer pipe; and
a sewage-supplying member configured to supply sewage into the carrier for providing nutrients for microorganisms to the carrier,
wherein the bio-filter unit includes:
a filter housing;
a guidance discharge pipe disposed at a lower part inside the filter housing and configured to discharge the N₂O transferred by the transfer pipe upwards through a nozzle while guiding the N₂O in a transverse direction;
a carrier disposed above the guidance discharge pipe inside the filter housing and configured to remove, by means of a microbial reaction, the N₂O discharged through the guidance discharge pipe; and
a sewage-spraying member disposed above the carrier inside the filter housing and configured to spray sewage supplied from the sewage-supplying member into the carrier for use as nutrients for microorganisms.

2. The bio-filter system of claim 1, wherein a bottom of the filter housing is formed to be inclined in order to collect sewage dropped from the carrier at one side, and a pump configured to pump the collected sewage for supply to the sewage-supplying member is further included.

3. The bio-filter system of claim 1, wherein a sewage tank of the sewage-supplying member is disposed above the sewage-spraying member so as to supply sewage to the sewage-spraying member by gravity.

4. The bio-filter system of claim 1, wherein the carrier consists of an open cell portion with a 70% void volume for facilitating gas transfer and a closed cell portion with a 30% void volume in which microorganisms are able to be securely immobilized, has a porosity of 11 to 13 ppi and a density of 35 kg/m³, and is made of a polypropylene resin.

5. The bio-filter system of claim 1, wherein the guidance discharge pipe is designed to gradually decrease in cross-sectional area as the distance from the transfer pipe increases.
